(19) United States
(12) Patent Application Publication
(10) Pub. No.: US 2014/0337805 A1
(43) Pub. Date: Nov. 13, 2014

(54) INFORMATION PROCESSOR AND COMPUTER PROGRAM PRODUCT

(71) Applicant: KABUSHIKI KAISHA TOSHIBA, Tokyo (JP)

(72) Inventor: Junko Shimoharada, Hamura-shi (JP)

(73) Assignee: KABUSHIKI KAISHA TOSHIBA, Tokyo (JP)

(21) Appl. No.: 14/178,128

(22) Filed: Feb. 11, 2014

(30) Foreign Application Priority Data
May 10, 2013 (JP) 2013-100641

(51) Int. Cl. G06F 3/0484; G06F 3/0488; G06F 3/01

(52) U.S. Cl. CPC G06F 3/04842; G06F 3/017; G06F 3/0488
USPC 715/863

(57) ABSTRACT

According to one embodiment, an information processor includes a detector and a controller. The detector is configured to detect position coordinates on a display screen specified with an object. The controller is configured to perform disabling based on the position coordinates detected by the detector. When a predetermined gesture operation by the object is received upon selection of a first link displayed on the display screen, the controller is configured to disable the selection of the first link based on the position coordinates. When the detector detects position coordinates near the first link, the controller is configured to disable a function of automatically selecting the first link.

### CROSS-REFERENCE TO RELATED APPLICATIONS

This application is based upon and claims the benefit of priority from Japanese Patent Application No. 2013-100641, filed May 10, 2013, the entire contents of which are incorporated herein by reference.

### FIELD

Embodiments described herein relate generally to an information processor and a computer program product.

### BACKGROUND

Recently, there has been a tendency to use an information processor based on a touch operation on a touch panel such as a smartphone and a tablet terminal. With such tendency, a tendency to achieve a touch operation also in a personal computer (PC), etc. is increasing. A display screen on which the touch operation is performed tends to enable higher resolution.

Thus, there is proposed a technique of preventing a link or the like displayed on a display screen to be selected by mistake, when the link is to be selected based on the touch operation.

In the conventional technique, it is proposed to cancel selection when a wrong link is selected. However, the conventional technique provides no control for suppressing the wrong link to be reselected. Thus, there is caused load on a user for an operation to select a desired link, or the like.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of an exterior of an information processor according to a first embodiment;

FIG. 2 is an exemplary diagram of one example of a hardware configuration of the information processor in the first embodiment;

FIG. 3 is an exemplary diagram of a software configuration of the information processor in the first embodiment;

FIG. 4 is an exemplary diagram of one example of a portion of a display screen displayed by a display controller in the first embodiment;

FIGS. 5A-5D are exemplary diagrams of a first example of screen transition when a link is selected, in the first embodiment;

FIGS. 6A-6D are exemplary diagrams of a second example of screen transition when a link is selected, in the first embodiment;

FIG. 7 is an exemplary flowchart of an entire procedure of link control processing in the information processor in the first embodiment;

FIG. 8 is an exemplary flowchart of determination processing of S707 of FIG. 7 performed by a determining module, in the first embodiment; and

FIGS. 9A-9D are exemplary diagrams of an example of screen transition when a link is selected, according to a second embodiment.

### DETAILED DESCRIPTION

In general, according to one embodiment, an information processor comprises a detector and a controller. The detector is configured to detect position coordinates on a display screen specified with an object. The controller is configured to perform disabling based on the position coordinates detected by the detector. When a predetermined gesture operation by the object is received upon selection of a first link displayed on the display screen, the controller is configured to disable the selection of the first link based on the position coordinates. When the detector detects position coordinates near the first link, the controller is configured to disable a function of automatically selecting the first link.

### First Embodiment

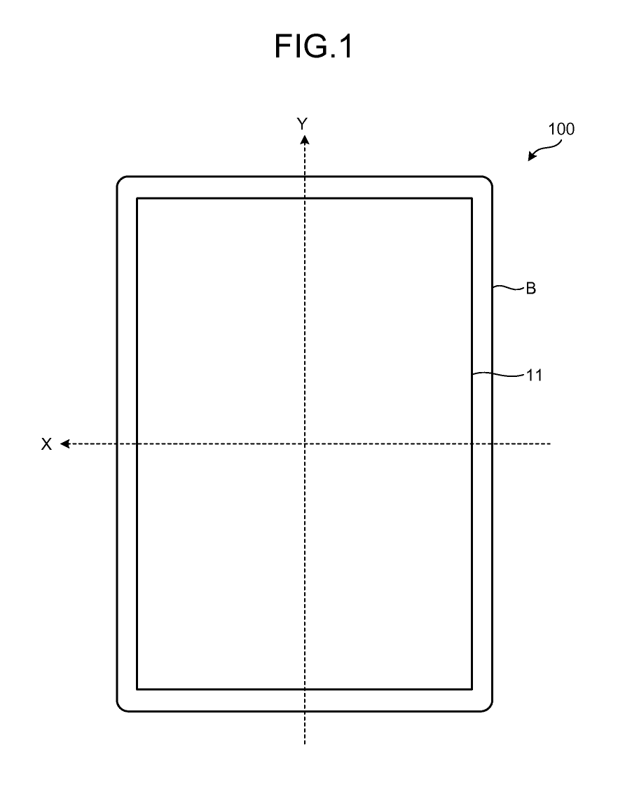

FIG. 1 is a schematic diagram of an exterior of an information processor according to the first embodiment. An information processor 100 is an information processor comprising a display screen, and is implemented as a tablet terminal, an electronic book reader, a digital photo frame, and a smartphone, for example. Here, the arrow directions of X-axis and Y-axis are defined as positive directions (the same hereinafter).

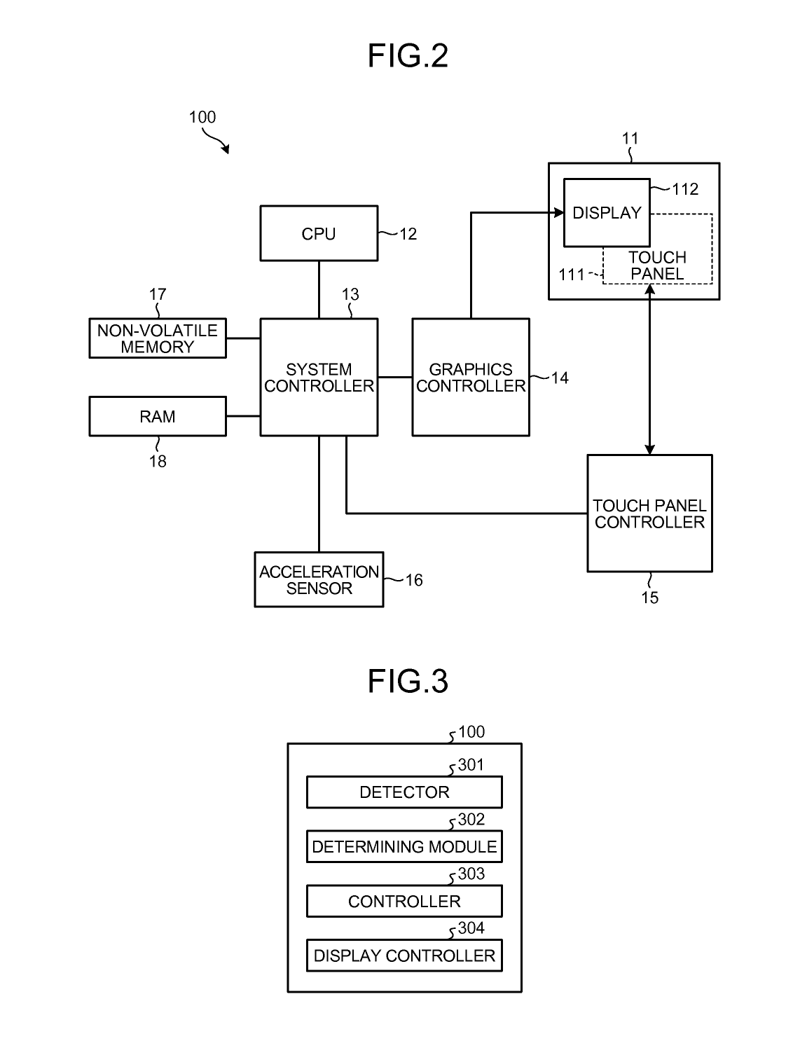

The information processor 100 comprises a housing B having a form of a thin box, and a display 11 is arranged on the upper face of the housing B. The display 11 comprises a touch panel for detecting a position on the display screen where a user has touched (see a touch panel 111 of FIG. 2). The information processor 100 is not limited to the example of FIG. 1, and may be configured such that various button switches are arranged on the upper face of the housing B.

FIG. 2 is a diagram of an example of a hardware configuration of the information processor 100. As illustrated in FIG. 2, the information processor 100 comprises a central processing unit (CPU) 12, a system controller 13, a graphics controller 14, a touch panel controller 15, an acceleration sensor 16, a non-volatile memory 17, a random-access memory (RAM), etc., in addition to the above-mentioned display 11.

The display 11 is configured by the touch panel 111 and a display 112 such as a liquid crystal display (LCD) and an organic electro-luminescence (OEL) display. The touch panel 111 is configured by a transparent coordinates detecting device arranged on the display screen of the display 112, for example. The touch panel 111 can detect a position on the display screen where the user has touched with his/her finger (touch position), as described above. With the function of the touch panel 111, the display screen of the display 112 serves as what is called a touch screen.

The CPU 12 is a processor controlling an operation of the information processor 100, and controls each component of the information processor 100 through the system controller 13. The CPU 12 executes an operating system and various application programs that are loaded from the non-volatile memory 17 to a RAM 18 so as to achieve each function module (see FIG. 3) described later. The RAM 18 serves as a main memory of the information processor 100.

The system controller 13 comprises a memory controller controlling access to the non-volatile memory 17 and the RAM 18. The system controller 13 also has a function of performing communication with the graphics controller 14.

The graphics controller 14 is a display controller controlling the display 112 used as a display monitor of the information processor 100. The touch panel controller 15 controls the touch panel 111, and acquires, from the touch panel 111, coordinate data indicating a position on the display screen of the display 112 where the user has touched.

The acceleration sensor 16 is an acceleration sensor of three axis directions (X, Y, and Z directions) or of six axis directions including such three axis directions and rotation directions around the three axes, for example. The acceleration sensor 16 detects an acceleration direction and degree relative to the information processor 100 from the outside, and outputs them to the CPU 12. To be more specific, the acceleration sensor 16 outputs an acceleration detection signal containing an axis, a direction (a rotation angle in case of the rotation) , and a degree of detected acceleration to the CPU 12. A gyroscopic sensor for detecting an angular velocity (rotation angle) may be integrated to the acceleration sensor 16.

FIG. 3 is a diagram of a software configuration of the information processor 100. As illustrated in FIG. 3, the information processor 100 achieves a detector 301, a determining module 302, a controller 303, and a display controller 304, in cooperation with the CPU 12 and software (operating system and various application programs).

The display controller 304 performs display control of the display screen of the display 112 through the graphics controller 14. A web page, etc., may be displayed on the display screen through a web browser, for example. In the first embodiment, the display controller 304 displays a cursor at position coordinates at which the detector 301 detects contact.

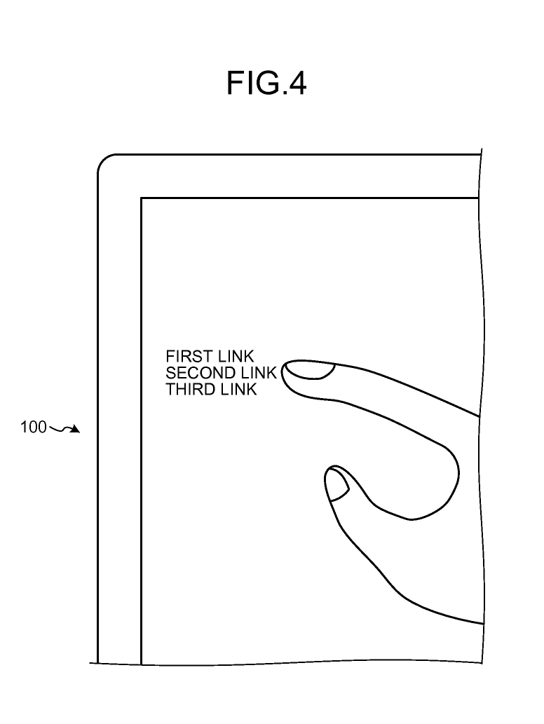

FIG. 4 is a diagram of an example of a portion of the display screen displayed by the display controller 304. A “first link”, a “second link”, and a “third link” that are displayed on the display screen illustrated in FIG. 4 are linked to different web pages from each other. The user can select the “first link”, the “second link”, or the “third link” through the touch panel 111.

When the user performs an operation with his/her finger, etc., through the touch panel 111, wrong detection may occur if a plurality of links are arranged adjacent to one another in a manner not appropriate in view of a size of the finger. In the example illustrated in FIG. 4, for example, even when the user desires to select the “second link”, the “first link” or the “third link” may be selected based on the position coordinates detected by the touch panel 111. Thus, in the first embodiment, the link control is performed in accordance with a gesture operation of the user.

The detector 301 detects, thorough the touch panel controller 15, position coordinates on the display screen that are specified with a user's finger, etc. (object), and displayed on the display 11.

The determining module 302 determines which link has been selected by the user based on the position coordinates detected by the detector 301. Then, the display controller 304 displays the link in a selected state based on the determination result. However, it is to be noted that there is a possibility that a wrong link is to be selected.

Thus, when a link displayed on the display screen is selected based on position coordinates detected by the detector 301, the determining module 302 in the first embodiment determines whether a predetermined gesture operation with a finger, etc. (object), has been received through the detector 301.

When the determining module 302 determines that the predetermined gesture operation has been received, the controller 303 performs control for disabling selection of the link selected before the gesture operation, or when the detector 301 detects position coordinates near the link selected before the gesture operation, the controller 303 performs control for disabling a function of automatically selecting the link (function of drawing the indicating cursor to the link).

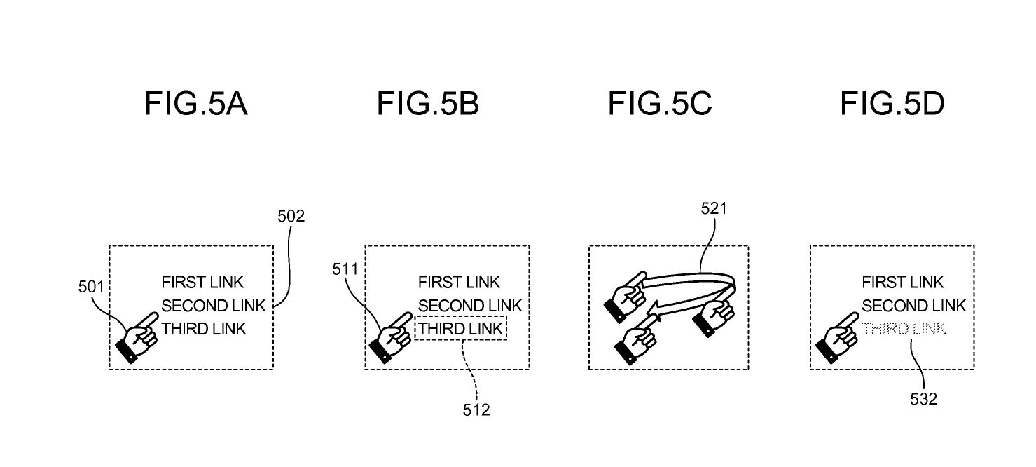

FIG. 5 is a diagram of a first example of screen transition when a link is selected. In the example illustrated in FIG. 5, a “first link”, a “second link”, and a “third link” are displayed on the display 11.

FIG. 5A illustrates an example in which the user intents to touch the “second link” 502 displayed on the display 11 with his/her finger (object) 501 to select the “second link” 502.

FIG. 5B illustrates an example in which the “third link” 512 is selected by mistake as a touch result with the finger 511 or the like in FIG. 5A. That is, when a finger of the user or the like is bigger than a display area of the “second link”, it may be difficult to correctly specify the “second link” with the finger or the like. In such a case, the determining module 302 may determine that position coordinates in a display area of the “third link” or position coordinates near the “third link” have been selected with the finger 511 or the like, and the display controller 304 may display the “third link” 512 in a selected state.

As described above, although the user intents to select the “second link”, wrong selection might occur supposing that the “third link” has been selected. Thus, in the information processor 100 in the first embodiment, a predetermined gesture operation for disabling, for example, the wrongly selected link is set.

FIG. 5C illustrates an example in which the user performs a predetermined gesture operation 521 with his/her finger or the like in response to the wrong selection in FIG. 5B.

In the information processor 100 in the first embodiment, a trigger for detecting a gesture operation for disabling, for example, the wrongly selected link is set.

In the first embodiment, a trigger for detecting a gesture operation is detection of start of a sliding operation by the user (detection of change of detected position coordinates by a predetermined distance or longer) while a link is selected.

In the first embodiment, the sliding operation of slightly waving a finger right and left for a predetermined short time period (two or three seconds, for example) is set as the predetermined gesture operation. That is, when the user performs, using his/her finger, an action such as to erase an object with an eraser, the link control is performed assuming that the link is selected by mistake.

The determining module 302 in the first embodiment acquires, as the predetermined gesture operation, a moving direction (dx, dy) and a ratio of the moving direction (di=dy/dx) based on the position coordinates detected by the detector 301.

If the moving direction and the ratio of the moving direction acquired from the detector 301 satisfy 0<di<1 and dx>0 three or more consecutive times, the determining module 302 determines “movement toward upper right”.

Similarly, if the moving direction and the ratio of the moving direction acquired from the detector 301 satisfy 0<di<1 and dx<0 three or more consecutive times, the determining module 302 determines “movement toward lower left”.

Then, the determining module 302 determines that the gesture operation of waving the finger right and left has been performed when the “movement toward upper right” and the “movement toward lower left” are detected alternately. In the first embodiment, the movement of a finger toward upper right and lower left, not toward right and left, is regarded as the gesture operation. This is because the user is supposed to hold the information processor 100 in his/her left hand and perform an operation with his/her right hand. That is, when the user is supposed to perform a gesture operation with his/her index finger of right hand in the first embodiment, the gesture operation with an angle of about 10° to 30° is considered to be easy. Then, in the first embodiment, an angle of 0° to 45° with an extra margin is set as an effective range as the gesture operation.

In the first embodiment, the sliding operation of alternately making “movement toward upper right” and “movement toward lower left” is detected as the predetermined gesture operation. However, the predetermined gesture operation is not limited thereto, and may be other gesture operations. For example, assuming that the operation is performed with a left hand, “movement toward lower right” and “movement toward upper left” may be determined alternately. It is also possible that an operation desired by the user is registered as the gesture operation.

FIG. 5D illustrates an example in which the controller 303 has performed control for disabling selection of the “third link” 532 in accordance with the gesture operation 521 in FIG. 5C. It can be recognized that the “third link” that is in a selected state in FIG. 5B is in gray-out in FIG. 5D and cannot be selected.

In this manner, upon receipt of the sliding operation, as the gesture operation, of a reciprocating movement in a predetermined direction (movement toward upper right, for example) and the opposite direction of the predetermined direction (movement toward lower left, for example) from the position coordinates detected by the detector 301 as a starting point, the controller 303 performs control for disabling selection of the link selected before the sliding operation, or control for disabling a function of automatically selecting the link selected before the sliding operation if position coordinates near the link are detected.

The first embodiment achieves, with the control described above, the cancelation of the link selected by mistake and the suppression of reselection of the link. In the first embodiment, it is possible to perform control for disabling selection of a link and then perform the same control regarding also other link.

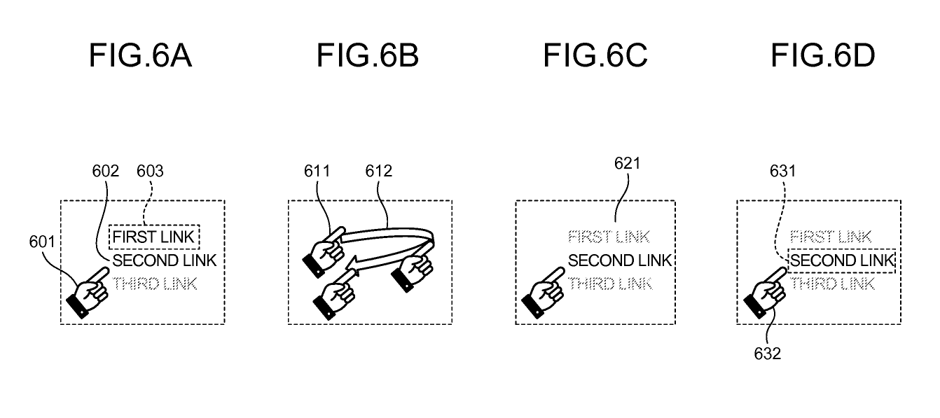

FIG. 6 is a diagram of a second example of screen transition when a link is selected. In the example illustrated in FIG. 6, a “first link” and a “second link” that can be selected, and a “third link” that cannot be selected are displayed on the display 11.

FIG. 6A illustrates an example in which the user intents to touch the “second link” 602 displayed on the display 11 with his/her finger (object) 601 to select the “second link”, but the “first link” 603 is selected by mistake.

FIG. 6B illustrates an example in which the user performs a gesture operation 612 with his/her finger 611 or the like in response to the wrong selection in FIG. 6A. Here, the gesture operation is the same as in FIG. 5C, and thus the description thereof is omitted.

FIG. 6C illustrates an example in which the controller 303 has performed control for disabling selection of the “first link” 621 in accordance with the gesture operation 612 in FIG. 6B. It can be recognized that the “first link” that is in a selected state in FIG. 6B is in gray-out in FIG. 6C and cannot be selected.

FIG. 6D illustrates an example in which the “second link” 631 is selected based on the position coordinates detected by the detector 301. When position coordinates in a display area of the “second link” 631 or position coordinates near the “second link” 631 are detected based on a touch with a finger 632, etc., the determining module 302 determines that the “second link” 631 has been selected because the “first link” and the “third link” cannot be selected, and the display controller 304 can display the “second link” in a selected state.

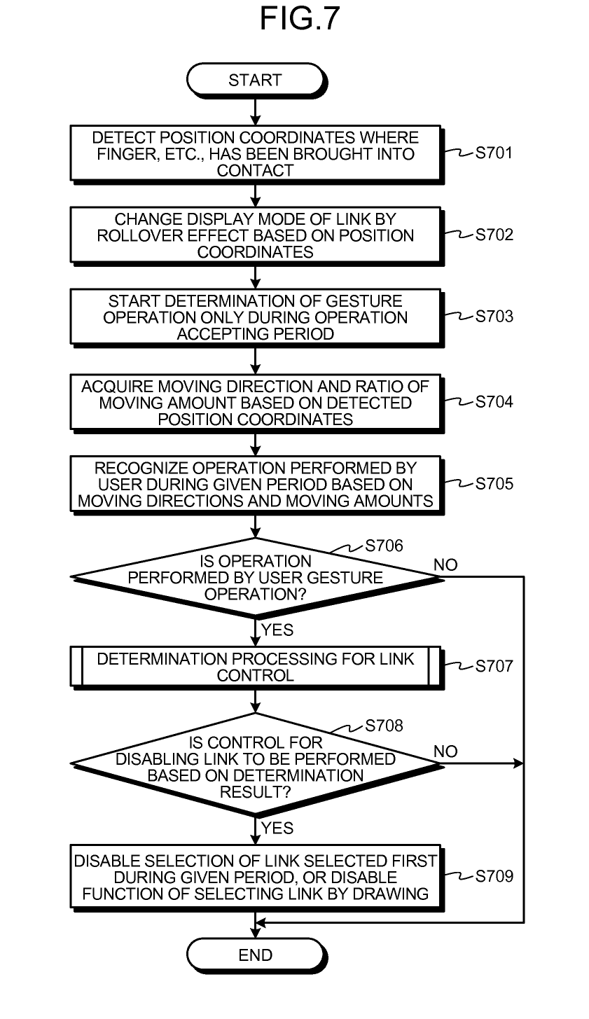

Next, the entire processing for link control of the information processor 100 in the first embodiment is described. FIG. 7 is a flowchart of the procedure of the above processing in the information processor 100 in the first embodiment.

First, the detector 301 detects position coordinates on the display 11 where a finger or the like has been brought into contact (S701).

Next, the display controller 304 changes a display mode of a link that can be considered as one specified by the user, by a rollover effect based on the detected position coordinates (S702). FIG. 5 of the first embodiment illustrate an example in which the display mode is changed so that the link is circled.

Subsequently, once a trigger for detecting a gesture operation is satisfied, the determining module 302 starts determination of a gesture operation only during an operation accepting period (5 seconds, for example) (S703). The trigger for detecting a gesture operation is described in the above, and thus the description thereof is omitted.

Then, the determining module 302 acquires a moving direction and a ratio of moving amount based on the position coordinates detected by the detector 301 (S704).

The determining module 302 recognizes an operation performed by the user during a predetermined period (three seconds, for example) based on moving directions and moving amounts acquired a plurality of times (S705). Thus, it is recognized that “movement toward upper right” and “movement toward lower left” are alternately performed repeatedly, for example.

Next, the determining module 302 determines whether the operation performed by the user is the predetermined gesture operation (S706). When it is determined that the operation is not the predetermined operation (No at S706), the processing is finished. In the first embodiment, the repeated operation of alternately making “movement toward upper right” and “movement toward lower left”, that is, the operation of slightly waving a finger right and left is registered as the predetermined gesture operation.

When the determining module 302 determines that the operation is the predetermined operation (Yes at S706), it performs determination processing whether the link control is to be performed regarding the selected link (S707). The determination processing is described later.

Thereafter, the determining module 302 determines whether the control for disabling the link is to be performed based on the determination result (S708). When the determining module 302 determines that the control for disabling the link is not to be performed (No at S708), the processing is finished.

When the determining module 302 determines that the control for disabling the link is to be performed based on the determination result (Yes at S708), the controller 303 performs control for disabling selection of the link selected first (before the gesture operation determination) during a predetermined period, or control for disabling a function of selecting the link by drawing (function of automatically selecting the link if the detector 301 detects position coordinates near the link) (S709).

In this manner, upon receipt of the sliding operation of making movement from the position coordinates as the predetermined gesture operation, the controller 303 in the first embodiment performs, during the sliding operation from the position coordinates, control for disabling selection of the link selected before the sliding operation if the detector 301 detects position coordinates included in a display area of other link different from the selected link, or control for disabling a function of automatically selecting the link selected before the sliding operation if position coordinates near the link are detected.

With the processing procedure described above, it is possible to not only cancel the link selected by mistake but also suppress reselection of the link, in accordance with an operation performed by the user.

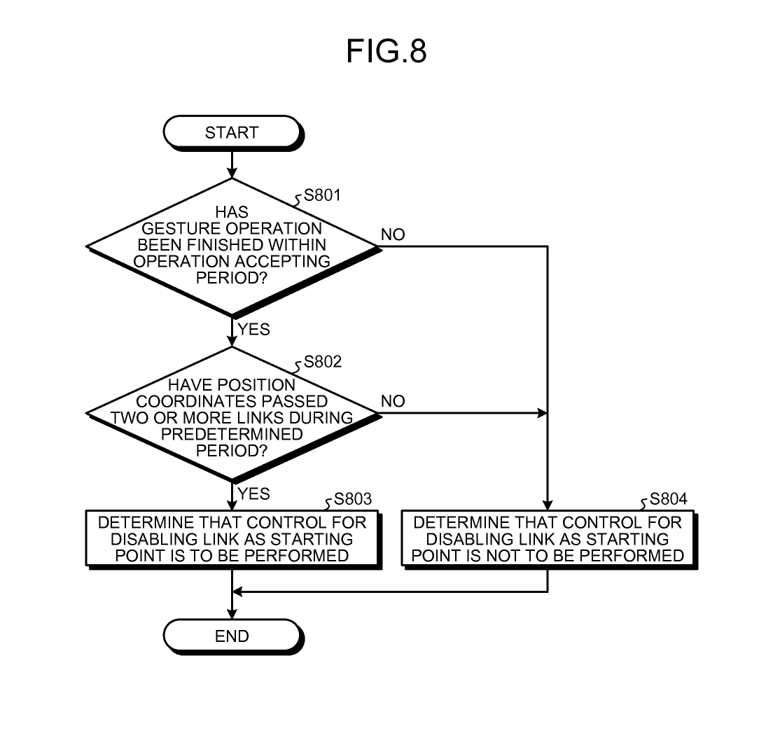

Next, the determination processing at S707 by the determining module 302 in the first embodiment is described. FIG. 8 is a flowchart of the procedure of the above-mentioned processing by the determining module 302 in the first embodiment.

First, the determining module 302 determines whether the gesture operation determined at S706 has been finished within the operation accepting period started at S703 (S801). When the determining module 302 determines that the gesture operation has not been finished within the operation accepting period (No at S801), it is determined that the control for disabling the link as a starting point (link selected before the gesture operation determination) is not to be performed (S804).

When the determining module 302 determines that the gesture operation has been finished within the operation accepting period (Yes at S801), it is determined whether the position coordinates detected during the gesture operation have passed two or more links during a predetermined period (S802). When a display area of a link expands over a predetermined range and the position coordinates have passed at least one portion of the display area, the determining module 302 may determine that the position coordinates have passed the link. Thus, when the position coordinates specified by the gesture operation have passed from a portion of a display area of the link as the starting point (link selected before the gesture operation determination) to a portion of a display area of another link, the determining module 302 may determine that the position coordinates have passed two or more links. When the determining module 302 determines that the position coordinates have not passed two or more links (No at S802), it is determined that the control for disabling the link as a starting point (link selected before the gesture operation determination) is not to be performed (S804).

The fact of whether the position coordinates have passed two or more links during a predetermined period is set as a condition for link control. This is because it is considered to be highly possible, when the position coordinates have passed two or more links during the gesture operation, that wrong selection has occurred because a plurality of links are adjacent to one another with the selected link as a reference.

In the first embodiment, when the determining module 302 determines that the position coordinates have passed two or more links (Yes at S802), it is also determined whether the distance between the link as a starting point and the link passed is shorter than a predetermined distance (72 pixels, for example). When the distance between the links is longer than the predetermined distance, the processing shifts to S804.

That is, in the embodiment, when the gesture operation is recognized and the two conditions are satisfied, the link control is performed. The first condition is that the position coordinates have passed a plurality of links during the gesture operation. The second condition is that the distance between the links is short. That is, the fact that a cursor has passed links during a short time is set as a condition because it is considered, in such a case, that wrong selection has occurred due to a plurality of links adjacent to one another. Moreover, the fact that the distance between the links is short is set as a condition in order to remove a case in which a cursor is merely moved at a high speed from one end to the other on the display screen. When these two conditions are satisfied, the control for disabling selection of a link, etc., is performed. The determination criterion is whether these two conditions are satisfied in the first embodiment. However, the determination criterion is not limited to such conditions, and may be any condition as long as the fact that a plurality of cursors are adjacent to one another can be recognized.

Then, when the determining module 302 determines that the distance between the links is shorter than the predetermined distance, it is determined that the control for disabling the link as a starting point (link selected before the gesture operation determination) is to be performed (S803). That is, when the determination at S803 is performed, the controller 303 performs control for disabling selection of the link selected first (before the gesture operation determination) during a predetermined period, or control for disabling a function of selecting the link by drawing (function of automatically selecting the link if the detector 301 detects position coordinates near the link).

In the first embodiment, either the control for disabling selection of the link, or the control for disabling a function of selecting the link by drawing (function of automatically selecting the link if the detector 301 detects position coordinates near the link) is performed during a predetermined period. Here, the user may be able to select which control is to be performed, or it is also possible to set preliminary so that one of such control is performed automatically.

### First Modification of First Embodiment

The information processor 100 in the first embodiment does not consider that a display screen is scrolled when a sliding operation is performed on the touch panel 111. However, in a tablet terminal and a smartphone that are proposed currently, the display screen is normally scrolled when the user performs a sliding operation touching his/her finger on the display screen. Thus, regarding the information processor 100 in the first modification of the first embodiment, the following describes a case in which the display screen is scrolled when a normal sliding operation is performed.

In the first modification, the detector 301 detects position coordinates where a finger or the like has been brought into contact. When a link is not in a selected state depending on the detection result of the position coordinates, that is, when the finger or the like has not been brought into contact with a display area of the link or an area near the link, the display controller 304 performs, if the detector 301 detects a sliding operation, display control for scrolling the display screen in accordance with the sliding operation.

When the link is in a selected state depending on the detection result of the position coordinates by the detector 301, that is, when the finger or the like has been brought into contact with a display area of the link or an area near the link, the display controller 304 does not perform, even if the detector 301 detects the sliding operation, display control for scrolling the display screen in accordance with the sliding operation, and the gesture operation detection processing same as in the first embodiment is performed.

That is, when the user touches a link or an area near the link on the display screen, it is considered to be highly possible that the user desires to move to a linked page through the link. Thus, in the information processor 100 in the first modification, the display screen is scrolled when a normal sliding operation is performed. However, when a link or an area near the link on the display screen is touched, a gesture operation is detected without performing scrolling control.

The shifting control in the first modification described above makes it possible to perform normally the conventional operation and further perform, when a link is selected by mistake, control for disabling selection of the link, for example, thus improving the convenience.

### Second Modification of First Embodiment

Although the first modification of the first embodiment describes an example in which the display screen is not scrolled while a link is selected, the first modification of the first embodiment does not intend to limit embodiments to such control that the display screen is not scrolled while a link is selected. Here, in a second modification of the first embodiment, an example in which the display screen is scrolled even while a link is selected is described.

That is, in the second modification, when a link is not in a selected state depending on the detection result of the position coordinates by the detector 301, that is, when the finger or the like has not been brought into contact with a display area of the link or an area near the link, the display controller 304 performs, if the detector 301 detects a sliding operation, display control for scrolling the display screen in accordance with the sliding operation.

When the link is in a selected state, that is, when the finger, etc. has been brought into contact with a display area of the link or an area near the link depending on the detection result of position coordinates by the detector 301, the display controller 304 performs, if the detector 301 detects the sliding operation, display control for scrolling the display screen in accordance with the sliding operation, and the gesture operation detection processing same as in the first embodiment is performed.

That is, when the user performs a gesture operation of alternately making “movement toward upper right” and “movement toward lower left” of his/her finger, the determining module 302 determines whether such an operation is the gesture operation, and the display controller 304 performs control for scrolling the display screen in accordance with the operation of alternately making “movement toward upper right” and “movement toward lower left”. Also when such control is performed, the same effect as in the first embodiment and the first modification can be obtained.

### Second Embodiment

The first embodiment describes an example in which the user selects a link displayed on a display screen by touching it with his/her finger. Currently, there is proposed a technique of operating an information processor without touching a display screen directly (floating touch, for example). That is, a finger or the like located at a position separated from a display screen is detected using a capacitance touch panel as the touch panel 111, and the operation is performed in accordance with the detected position.

The first embodiment does not limit embodiments to a case in which the user selects a link displayed on a display screen by touching it directly with his/her finger, etc., and the technique of achieving the operation without touching the display screen directly may be applied. Here, the second embodiment describes an example in which the detection of a gesture operation, etc., is achieved by detecting a finger or the like located at a position separated from the display screen.

The touch panel 111 in the second embodiment comprises various kinds of capacitance sensors. One of them is of “self-capacitance type” having high sensitivity, and can detect a finger even if it does not touch a display screen directly. The other is of “mutual-capacitance type” and allows multi-touch detection. It is possible, with these various kinds of capacitance sensors, to detect not only a position of a finger having been brought into contact with the display 11 directly but also a position of a finger having not been brought into contact with the display screen directly. Regarding the touch panel 111, any system can be employed as long as an object adjacent to the display screen can be detected.

In this manner, the detector 301 can detect an object coming into contact with or getting closer to the display screen of the display 11. That is, the first embodiment allows detection of position coordinates of an object only in the X-axis and Y-axis directions illustrated in FIG. 1, while the second embodiment allows detection of position coordinates of the object in the Z-axis direction perpendicular to the plane coordinate system of the display screen that is a plane coordinate system defined with the X-axis and the Y-axis.

Then, the determining module 302 determines which link has been selected by the user based on the position coordinates of his/her finger or the like adjacent to the display screen that are detected by the detector 301. Then, the display controller 304 displays the link in a selected state based on the determination result.

Thereafter, the determining module 302 determines whether a gesture operation has been performed with the finger or the like not in contact with the display screen, in other words, the finger or the like adjacent to the display screen. After the gesture operation is determined, the controller 303 performs link control with the contact of the finger or the like of the user on the display screen as a trigger.

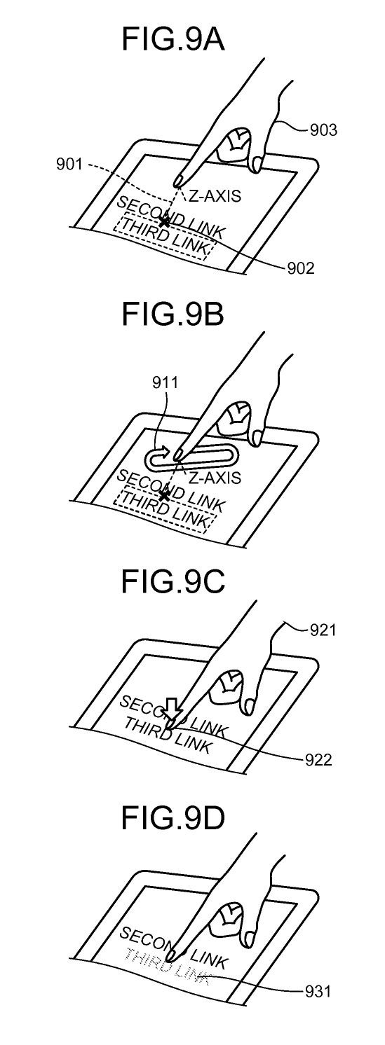

FIG. 9 is a diagram of an example of screen transition when a link is selected. In the example illustrated in FIG. 9, a “second link” and a “third link” are displayed on the display 11.

FIG. 9A illustrates an example in which the user puts his/her finger (object) 903 adjacent to an display area 902 where the “second link” is displayed on the display 11 to select the “second link”. The finger 903 is separated from the display 11 by a distance 901 in the Z-axis direction. Then, the user intents to touch the “second link” displayed on the display 11 with his/her finger (object) 903, but the “third link” is selected by mistake.

FIG. 9B illustrates an example in which the user performs a gesture operation 911 with his/her finger or the like in response to the wrong selection in FIG. 9A. The gesture operation is same as in the first embodiment, and thus the description thereof is omitted.

FIG. 9C illustrates an example in which the controller 303 performs control for disabling selection of the “third link” 922 in accordance with the gesture operation 911 in FIG. 9B. In FIG. 9C, when the display screen is touched with a finger 921 after the gesture operation illustrated in FIG. 9B, the gesture operation is confirmed. With this, the determining module 302 also determines that the gesture operation has been performed.

FIG. 9D illustrates an example in which the controller 303 has performed control for disabling selection of the “third link” 931 in accordance with the gesture operation 911 in FIGS. 9B and 9C. It can be recognized that the “third link” that is in a selected state in FIG. 9B is in gray-out in FIG. 9D and cannot be selected.

With the processing procedure described above, even when a link is selected wrongly while a finger or the like of the user is not in contact with a display screen, it is possible to cancel the wrong selection and suppress reselection of the link selected by mistake.

The above-mentioned embodiments and the modifications describes cases in which a tablet terminal, etc. is applied as an information processor. However, an embodiment is not limited to the tablet terminal, etc., and may be applied to a PC comprising a pointing device. For example, if the contact in the second embodiment is achieved by click of a pointing device, the processing described in the second embodiment can be applied to the PC, etc.

Conventionally, it is difficult to select a desired link when a plurality of links are adjacent to one another, in an information processor comprising a touch panel or the like. Thus, in the embodiments and the modifications described above, the control for temporarily disabling a link not desired, among adjacent links, or temporarily disabling a function of automatically selecting the link is performed.

A link not desired is disabled or a function of drawing a cursor, etc., to the link is disabled in this manner, which makes it easier for the user to select a desired link. Thus, when a desired link is not selected and the surrounding links are always selected, the selection of the surrounding links is suppressed temporarily to decrease a user's operation load.

A control program executed in the information processor in the embodiments and the modifications described above is recorded, as a file whose format is installable or executable, in a computer readable recording medium such as a compact disk read only memory (CD-ROM), a flexible disk (FD), a compact disk recordable (CD-R), and a digital versatile disk (DVD), and then provided.

The control program executed in the information processor in the embodiments and the modifications described above may be stored in a computer connected to a network such as the Internet, and then provided by download thereof through the network. Alternatively, the control program executed in the information processor in the embodiments and the modifications described above may be provided or distributed through a network such as the Internet.

The control program executed in the information processor in the embodiments and the modifications described above may be preliminarily embedded in a ROM, etc., and then provided.

The control program executed in the information processor in the embodiments and the modifications described above is of a module configuration comprising the modules described above (detector, determining module, controller, and display controller). As actual hardware, the CPU (processor) reads out the control program from the recording medium, and executes it, whereby the modules described above are loaded on the main memory, and the detector, the determining module, the controller, and the display controller are generated on the main memory.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a detector configured to detect position coordinates on a display screen specified with an object; and
a controller configured to perform disabling based on the position coordinates detected by the detector, wherein,
when a predetermined gesture operation by the object is received upon selection of a first link displayed on the display screen, the controller is configured to disable the selection of the first link based on the position coordinates, or,
when the detector detects position coordinates near the first link, the controller is configured to disable a function of automatically selecting the first link.

2. The information processor of claim 1, wherein,
upon receipt of a sliding operation from the position coordinates as the predetermined gesture operation and during the sliding operation from the position coordinates, when the position coordinates detected by the detector is within a display area of a second link different from the first link, the controller is configured to disable the selection of the first link which had been selected before the sliding operation, or,
when the detector detects position coordinates near the first link, the controller is configured to disable the function of automatically selecting the first link.

3. The information processor of claim 1, wherein,
upon receipt of a sliding operation of a reciprocating movement started from the position coordinates detected by the detector in a predetermined first direction and a second direction opposite the first direction as the predetermined gesture operation, the controller is configured to disable the selection of the first link which had been selected before the sliding operation, or,
when the detector detects position coordinates near the first link, the controller is configured to disable the function of automatically selecting the first link.

4. The information processor of claim 1, wherein
the detector is configured to be capable of detecting the object that is in contact with or approaching the display screen, and,
upon selection of the first link displayed on the display screen, when a predetermined gesture operation by the object detected by the detector as approaching the display screen is received, the controller is configured to disable the selection of the first link, or,
when the detector detects position coordinates near the first link, the controller is configured to disable the function of automatically selecting the first link.

5. A computer program product having a non-transitory computer readable medium including programmed instructions, wherein the instructions, when executed by a computer, cause the computer to perform:
detecting position coordinates on a display screen specified with an object; and
performing disabling based on the position coordinates detected by the detecting, wherein,
when a predetermined gesture operation by the object is received upon selection of a first link displayed on the display screen, the performing performs disabling of the selection of the first link based on the position coordinates, or,
when the detecting detects position coordinates near the first link, the performing performs disabling of a function of automatically selecting the first link.
